(19) United States
(12) Patent Application Publication
(10) Pub. No.: US 2011/0123734 A1
(43) Pub. Date: May 26, 2011

(54) FLAT VACUUM GLASS STRUCTURE

(76) Inventors: FRANK YANG, Taipei (TW); Ming-Chun Ho, Taipei (TW); Chang-Jen Huang, Taipei (TW); Kuo-Hua Chen, Taipei (TW); Shih-Chien Hsiao, Taipei (TW); Cheng-Chieh Kao, Taipei (TW); Chih-Che Kuo, Taipei (TW); Kuo-Chih Yang, Taipei (TW); Chuei-Chuan Wang, Taipei (TW)

(21) Appl. No.: 12/857,547

(22) Filed: Aug. 16, 2010

Related U.S. Application Data
(63) Continuation-in-part of application No. 12/591,612, filed on Nov. 25, 2009.

(51) Int. Cl. B32B 3/08; E06B 3/00

(52) U.S. Cl. 428/34

(57) ABSTRACT

A vacuum glass structure comprising two glass substrates maintained at an substantially constant interval by a glass frit paste sealingly adhering to the peripheries thereof, forming a hermetically sealed vacuum room. A receiving gap is formed at the periphery of the glass substrate. The internal surface of the glass structure further includes an air chamber and a glass tube groove for receiving a pumping tube. The pumping tube can be placed inside the receiving gap with the internal end of the pumping tube extending from the receiving gap through the glass tube groove into the air chamber. The external end of the pumping tube constitutes a hermetic seal retained within the geometric boundary of the receiving gap. The air chamber structure may improve air transferring efficiency and prevents problems such as blockage in the pumping tube, thus enabling an increase in production yield.

### CROSS REFERENCE TO RELATED APPLICATION

This application is a continuation-in-part of U.S. application Ser. No. 12/591,612 filed on Nov. 25, 2009, now pending.

### BACKGROUND OF THE INVENTION

1. Field of the Invention

The instant disclosure relates to a vacuum glass structure. In particular, the instant disclosure relates to a flat vacuum glass structure that achieves internal vacuum by means of air extraction through a pumping tube.

2. Description of Related Art

Vacuum in a glass structure can be achieved by first using two glass substrates separated at a suitable distance in between, bonding them with adhesives at the periphery, and then exhausting/extracting air molecules from the internal cavity with a vacuum pump, and further placing the getter material in the cavity. The internal vacuum pressure may range approximately from 10⁻² to 10⁻⁷ torr. This conventional technique can be applied to vacuum glass components in the Field Emission Display (FED), Vacuum Fluorescent Display (VFD), Plasma Display Panel (PDP), and so forth.

There are several ways for making the vacuum glass. For example, one common approach is to extract gas molecules out of the cavity through a glass pumping tube, and then hermetically seal and truncate the tube. The truncation of the hermetic seal is accomplished by melting the glass pumping tube with a local heating process upon completion of vacuum extraction system. However, because the working temperature required to melt glass is relatively high, the heating point for melting the glass pumping tube can not be too close to the glass substrate, thus to prevent cracking in the glass substrate due to the effect of high thermal gradient. As a result, a small piece of the glass pumping tube will unavoidably remain on the outside of the glass substrate after the fusion and cut-off processes. This type of glass pumping tube would leave a remaining protrusion from the surface of the glass substrate. In applications, although this problem may be reduced through suitable mechanical designs, the conventional design still can not achieve total planarization on the surface of the vacuum glass substrate. Furthermore, basing on numerous relevant experiments, it is shown that the protrusion of the glass pumping tube from the glass substrate is a necessary result from the conventional manufacturing technique, and is inevitable.

In order to resolve the aforementioned issue concerning the protrusion of the glass pumping tube from the glass substrate, a structural design of vacuum glass substrate has been developed. The improved design introduces a recessive gap respectively at the edges of two glass substrates, with the internal end of the pumping tube located inside of the cavity formed by the two glass substrates and the seal, and the axle of the pumping tube being parallel to the surface of the glass substrate, thereby allowing that the external end of the pumping tube after hermetic seal can be located within the geometric space constituting the gap so as to prevent the hermetically sealed pumping tube from protruding out of the two glass substrates.

However, during manufacturing processes, the internal end of the pumping tube is directly installed between the two glass substrates. This may lead to the existence of lower air transferring efficiency, or result in connection blockage in the pumping tube by the seal of the glass frit. Therefore, improvements for the aforementioned vacuum glass substrate structure remains to be desired.

Accordingly, in view of the amendable defects found in prior art as previously described, the inventors of the instant disclosure have proposed the instant disclosure featuring reasonable design and effectiveness in improving the aforementioned drawbacks.

### SUMMARY OF THE INVENTION

The objective of the instant disclosure is to provide a vacuum glass substrate structure having enhanced of air transferring efficiency and eliminating pumping tube blockage. Besides, it can successfully achieve the planarization of glass surface without additional mechanism designs.

To accomplish the objective above, the instant disclosure provides a vacuum glass substrate structure comprising at least two glass substrates arranged parallel to each other with a constant distance in between and the glass frit applied to join the peripheries of the glass substrates and seal the glass structure.

The glass substrates and the glass frit jointly constitute a hermetically sealed vacuum room. A receiving gap is installed at the periphery of the glass substrate toward the inward direction, and the internal surface of the glass substrate is further installed with an air chamber formed to be in communication with the vacuum room, as well as a glass tube groove for receiving a pumping tube. The air chamber is adjacent to the receiving gap, with the air chamber, the glass tube groove and the receiving gap being connected in series. The pumping tube is located within the receiving gap with the internal end of the pumping tube extending from the receiving gap into the air chamber through the glass tube groove, and is in communication with the air chamber. Glass fit adheres to the external edge of the pumping tube extending into the glass tube groove in order to hermetically seal the glass tube groove, while the external end of the pumping tube does not surpass the geometric space forming the receiving gap and is also sealed.

Preferably, the periphery of the air chamber, G, and the capacity of the air chamber, C, essentially follow the relationship equations as below:

G≧2×Pi×R and

C≧Pi×R2×h,

where Pi indicates the ratio of the circumference of a circle to the diameter (π), R the radius of the external circumference of the pumping tube, and h the interval between the two glass substrates.

The beneficial effects that the instant disclosure can provide include: a structure of air chamber is added to the location where the pumping tube couples to the internal vacuum room, such that during the aforementioned manufacture processes it facilitates to improve air transferring efficiency and eliminate concerns about such as accidental blockage in the pumping tube caused by the adherence of glass frit and the like, thus enhancing the product yield through the design of such an air chamber structure.

Besides, by means of the installation of such a receiving gap structure, the sealed and truncated pumping tube will not protrude out of the rim or surface of the two glass substrates, but accommodated inside of the receiving gap, so as to achieve the objective of planarization in the two glass substrates without any additional mechanism designs to overcome the defects in non-planarization.

In order to further appreciate the features and technical contents of the instant disclosure, references are made to the detailed descriptions and appended drawings as below; however, the appended drawings shown herein are simply referential and illustrative, rather than for limiting the scope of the instant disclosure.

### BRIEF DESCRIPTION OF THE DRAWINGS

FIG. 1 is a disassembly stereogram of the instant disclosure.

FIG. 2 is an assembly stereogram of the instant disclosure.

FIG. 3 is a top view (1) of the instant disclosure.

FIG. 4 is a top view (2) of the instant disclosure showing that the pumping tube is accommodated in the receiving gap after being hermetically sealed.

FIG. 5 is a plane side view of the instant disclosure showing that the air chamber is formed in the lower glass substrate.

FIG. 6 is another plane side view of the instant disclosure showing that the air chamber is conjunctively formed by the upper and lower glass substrates.

FIG. 7 is a top view (3) of the instant disclosure showing an embodiment of variation on the placement of the receiving gap.

FIG. 8 is a top view (4) of the instant disclosure showing an embodiment of variation on the placement of the receiving gap.

### DETAILED DESCRIPTION OF THE PREFERRED EMBODIMENTS

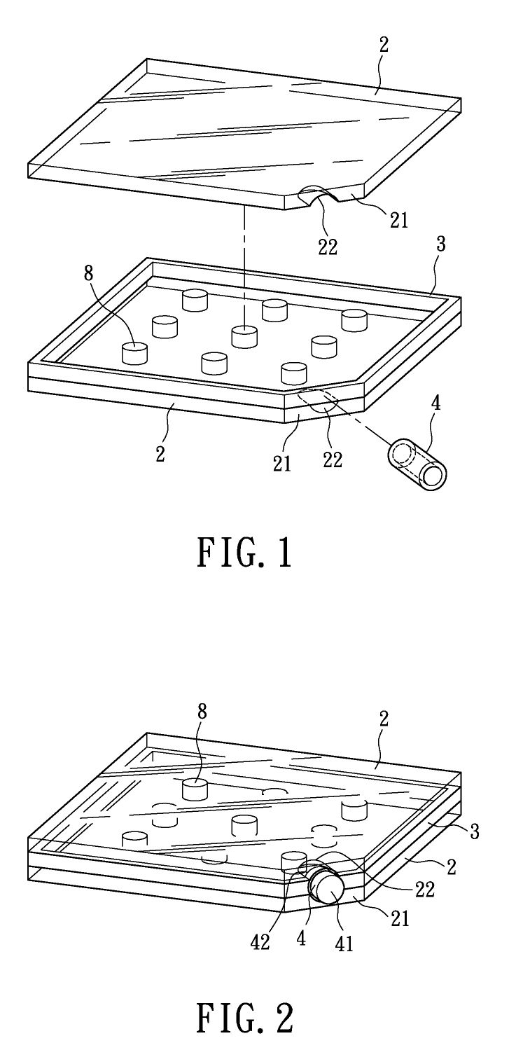

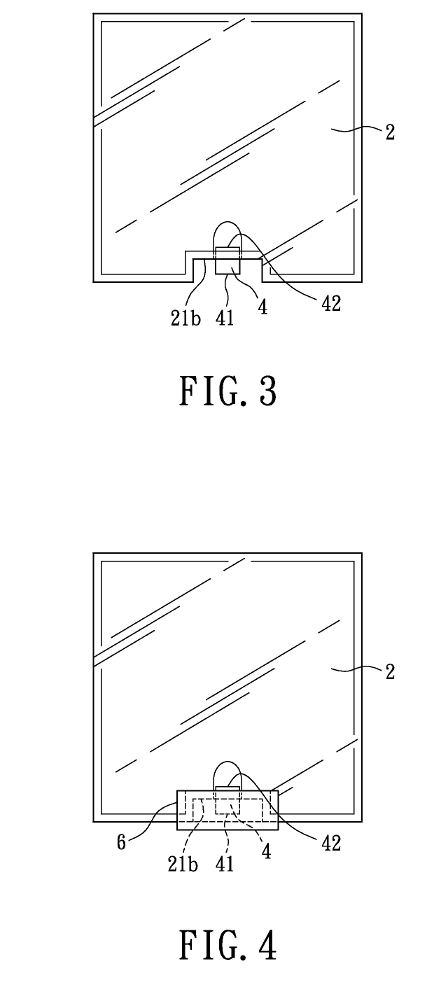

Refer now to FIGS. 1 to 3, wherein the instant disclosure provides a vacuum glass substrate structure comprising two glass substrates 2, a pumping tube 4 and a glass frit 3.

The two glass substrates 2 are arranged parallel to each other and maintained a constant distance in between. A corresponding receiving gap 21 is disposed at the periphery thereof toward an inward direction. A glass tube groove 22 is further recessively disposed on the internal surface of the adjacent sides of the two glass substrates 2. The air chamber 5 is close to the receiving gap 21, and the glass tube groove 22 is connected in series with the air chamber 5 and the receiving gap 21. In addition, a supporter 4 is installed between the two glass substrates 2 thereby separating and supporting the two glass substrates 2 maintaining a constant interval in between.

The pumping tube 4 is placed at the receiving gap 21 in the glass substrate 1, with the internal end of the pumping tube 4 extends from the receiving gap 21 into the air chamber 12 through the glass tube groove 22 so that pumping tube 4 is allowed to communicate with the air chamber 12.

The glass frit 3 may be a glass paste, and is applied to the periphery of the two glass substrates 2 sealing the two glass substrates 2 hermetically (under a solidification condition of 460° C. for 30 minutes). Thus, the glass frit 3 and the two glass substrates 2 jointly form a vacuum room 14. Also, the glass fit 3 sticks to the outer rim of the pumping tube 4 and extends into the glass tube groove 22 to provide a hermetic seal between the edge of the glass tube groove 22 and the air chamber 12. Accordingly, the air chamber 12 can be in gas communication with the vacuum room 14.

To further illustrate the operations of vacuum extraction, a vacuum pump (not shown) is used to extract gas molecules from inside of the vacuum room 14 via the pumping tube 4, placing the vacuum room 14 under a highly vacuum state (10⁻²˜10⁻⁷ torr). During extractions, the internal end of the pumping tube 4 extends into the air chamber 12 and gradually pumps gas molecules out of the vacuum room 14, the inside of vacuum room 14 can thus reach the desired vacuum condition through extractions. Upon reaching the desired vacuum conditions, an appropriate heating devices, e.g., a heating coil 5, is employed to locally heat up the external end of the pumping tube 4 (at a preferred temperature ranging between 600° C. and 700° C.). The location where the pumping tube 4 is locally heated will melt and form a fusion bump thereby enabling completion of hermetic sealing to the pumping tube 4, resulting in evacuation of the vacuum room 14. Finally, as shown in FIG. 4, the pumping tube 4 is truncated at the fusion bump and hermetically sealed to form an external end 22. Thus, the external end 22 can be kept within the geometric boundary of the receiving gap 21 without protruding. The planarization of structural surface of the glass substrates 2 can therefore be retained.

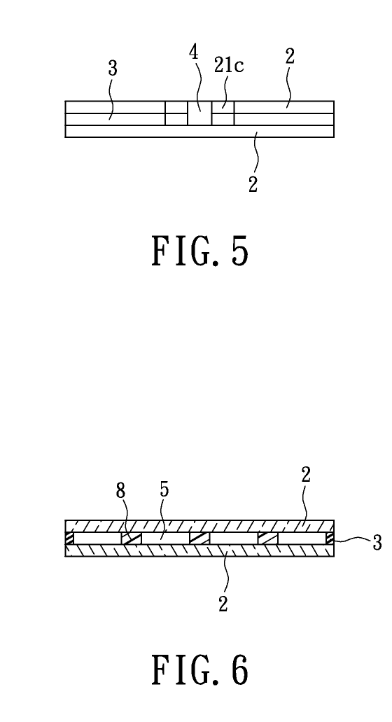

In the instant disclosure, as shown in FIG. 5, the air chamber 12 can be installed recessively on the inner surface of any one of the two glass substrates 2. That is, either the upper or the lower glass substrate alone can provide the space for constructing the air chamber; or alternatively, as shown in FIG. 6, the air chamber 12 is installed in recess jointly on the inner surface of the two glass substrates 2. In other words, the air chamber is provided by both the upper and the lower glass substrates at the same time. The profile of the air chamber 12 may be cylindrical, rectangular or of any other geometries, and the size thereof can be also designated based on the requirements of practical implementations.

Preferably, the periphery of the air chamber 12, G, and the capacity of the air chamber 12, G, essentially follow the relationship equations as below:

G≧2×Pi×R and

C≧Pi×R2×h,

where Pi indicates the ratio of the circumference of a circle to the diameter (π), R the radius of the external circumference of the pumping tube, and h the interval between the two glass substrates.

In accordance with the equations illustrated as above, it is possible to effectively reduce the bottleneck existing in the air transferring flow and prevent the occurrence of pumping tube blockages. In the design of the instant disclosure, since the air chamber 12 and the pumping tube 4 respectively belong to two different geometrical blocks, due to the required communication between them, the external edge of the pumping tube 4 is therefore taken to define the minima of the volume and circumference in the air chamber 12 without imposing any limits on the geometry thereof. Thus, the air chamber 12 can be of cubic, elliptical, cylindrical, spherical or even irregular shapes, and the geometry of the air chamber 12 is only restricted by the minima of the volume and circumference thereof. However, the profile of the air chamber 12 is by no means limited to the cylinder-like shape shown in the diagram of the instant disclosure and the cross-section of the pumping tube 4 is not limited to be circular, either. The relationships regarding to geometry sizes between the air chamber 12 and the pumping tube 4 can be approximated based on the aforementioned equations or other suitable mathematic formula for further designing geometry sizes of the air chamber and the pumping tube.

In addition, the air chamber 12 can be further used for the placement of the getter material in order to provide and preserve the desired vacuum condition.

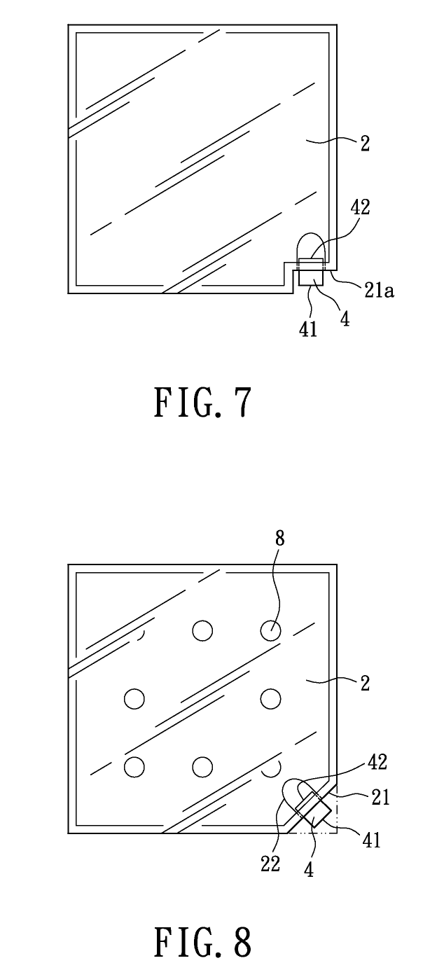

Also, in the embodiments shown as FIGS. 1 to 4, the receiving gap 21 is installed at the center on one side of the two glass substrates 2. For example, in case that a pumping tube 4 having an external diameter of 5 mm is used, the depth of the receiving gap 21 inwardly recessed can be 4 mm, which is sufficient for accommodating the protruding pumping tube 4 after sealing. However, the location where the receiving gap is installed is by no means limited thereto. As shown in FIGS. 7 and 8, the receiving gap 21 and 21a may be also installed at a peripheral location on a lateral side or a corner of the two glass substrates 2. Alternatively, the receiving gap may be formed by inwardly excavated from one of the common outer top side and outer bottom side on the periphery of the two glass substrates 2 (not shown). Take another example, as shown in FIG. 7, wherein the receiving gap 21a is constructed by cutting in slant one of the four lateral corners of the two glass substrates 2; that is, the geometric space of the receiving gap 21a is triangular, while the external end 22 of the pumping tube 4 should not surpass the apex of the triangular receiving gap 21a. For further illustrations, in the present embodiment, two glass substrates with each having a thickness of 3 mm can be selected, a pumping tube of 3 mm in the external diameter can be used, and the safe design value for the protrusion length of the pumping tube after sealing is 4 mm. Therefore, based on the mathematic formula for the three sides of a right triangle, truncating 5.6 mm in both lateral and longitudinal lengths at the corner of the glass substrates allows for accommodating and “burying” the 4 mm protrusion of the pumping tube within the geometric space of the gap.

From the illustrations set forth as above, it can be seen that the instant disclosure adds an air chamber structure at the location where the pumping tube links to the internal vacuum room, such that, during the aforementioned manufacture processes, the air transferring efficiency can be enhanced and the concerns about accidental blockage in the pumping tube by the glass frit and the like can be effectively prevented, thus achieving the improvement in product yields by means of the air chamber structure according to the instant disclosure.

Meanwhile, through the design of a receiving gap structure, the truncated pumping tube does not protrude out of the edge or surface of the two glass substrates. Rather, but the truncated end of the tube is contained inside of the receiving gap, such that the objective of surface planarization in the two glass substrates can be successfully achieved without having to install extra mechanism designs to eliminate such a non-planarization defects. Therefore, the instant disclosure advantageously enables applications in products like construction glasses, Field Emission Display (FED), Vacuum Fluorescent Display (VFD), Plasma Display Panel (PDP) etc. requiring both the features of heat isolation and light transmission.

The texts illustrated hereinbefore simply set forth the preferred embodiments of the instant disclosure, rather than limiting the scope of the instant disclosure. All effectively and structurally equivalent changes, modifications and alternations made thereto in accordance with the disclosures and appended drawings of the instant disclosure are therefore deemed as being included in the scope of the instant disclosure defined in the following claims.

What is claimed is:

1. A vacuum glass substrate structure, comprising:
at least two glass substrates arranged substantially parallel to each other at a substantially constant distance; and
an adhesive paste applied on the peripheries of the glass substrates for forming a closed room between the glass substrates through thermal curing;
wherein the glass substrates and the glass frit jointly constitute a hermetically sealed vacuum room,
wherein a receiving gap is disposed at the periphery of the glass substrate toward the inward direction,
wherein the internal surface of the glass substrate is further recessively installed with an air chamber formed to be in communication with the vacuum room,
wherein a glass tube groove for receiving a pumping tube, in which the air chamber is adjacent to the receiving gap, with the air chamber, the glass tube groove and the receiving gap being connected in series;
wherein the pumping tube is located within the receiving gap with the internal end of the pumping tube extending from the receiving gap into the air chamber through the glass tube groove and is in communication with the air chamber,
wherein the glass frit adheres to the external edge of the pumping tube extending into the glass tube groove in order to hermetically seal the glass tube groove, and
wherein the external end of the pumping tube does not surpass the geometric space forming the receiving gap and is also sealed.

2. The flat vacuum glass structure according to claim 1, wherein the periphery of the formed air chamber, G, and the volume of the air chamber, C, essentially follow the relationship equations as below:
G≧2×Pi×R
C≧Pi×R2×h,
where Pi indicates the ratio of the circumference of a circle to the diameter (π), R the radius of the external circumference of the pumping tube, and h the interval between the two glass substrates.

3. The vacuum glass substrate structure according to claim 2, wherein the air chamber is formed in recess from the internal surface on one of the two glass substrates.

4. The vacuum glass substrate structure according to claim 2, wherein the air chamber is formed in common recess from the internal surfaces on the two glass substrates.

5. The vacuum glass substrate structure according to claim 1, wherein a supporter is further installed between the two glass substrates in order to support and separate the two glass substrates.
